(19) United States
(12) Patent Application Publication
(10) Pub. No.: US 2016/0017929 A1
(43) Pub. Date: Jan. 21, 2016

(54) Propeller Shaft and Adapter Member for Propeller Shaft

(71) Applicant: HITACHI AUTOMOTIVE SYSTEMS KYUSHU, LTD., Chikujo-gun, Fukuoka (JP)

(72) Inventors: Kenichi SUGIYAMA, Atsugi-shi, Kanagawa (JP); Yasutomo MABE, Zama-shi, Kanagawa (JP); Hiromichi KOMAI, Hadano-shi, Kanagawa (JP)

(73) Assignee: HITACHI AUTOMOTIVE SYSTEMS KYUSHU, LTD., Chikujo-gun, Fukuoka (JP)

(21) Appl. No.: 14/771,836

(22) PCT Filed: Feb. 26, 2014
(86) PCT No.: PCT/JP2014/054624

§ 371 Date: Sep. 1, 2015

(30) Foreign Application Priority Data
Mar. 4, 2013 (JP) 2013-041454

(51) Int. Cl. F16D 3/226; F16D 1/10

(52) U.S. Cl. CPC F16D 3/2265; F16D 1/101; F16D 2003/22313

(57) ABSTRACT

Provided is a low-cost propeller shaft adaptable to multiple variations of input/output shafts.

An input shaft 3 and a first constant-velocity joint 4a are connected through a first adapter member 6a. The first adapter member is equipped with: a male spline 42 formed on an outer peripheral surface of a small-diameter shaft section 39 and engaged with a female spline 20 of an inner-race member 11 in the first constant-velocity joint 4a; and a female spline 46 formed on an inner peripheral surface of a large-diameter shaft section 41 and engaged with a male spline 35 of the input shaft 3. As a result, by producing only this first adapter member 6a, it is possible to adapt to an input shaft 3 of a type in which the outer diameter, the length in the axial direction, or the shape of the male spline 35 differs from an existing type.

### TECHNICAL FIELD

The present invention relates to a propeller shaft used in an automotive vehicle, for example, and to an adapter member for the propeller shaft.

### BACKGROUND OF THE INVENTION

Usually, a propeller shaft for an automotive vehicle has a construction which can be divided by a drive shaft connected to the transmission side and a driven shaft connected to the differential gear side into two or three parts, and additionally provided with a joint mechanism such as Cardin joint and a constant-velocity joint at the dividable facing ends while being rotatably supported on a vehicle floor through a supporting device disposed at an almost middle position in the axial direction.

The connection between the transmission and the drive shaft or the connection between the differential gear and the driven shaft is established by a spline coupling where an input shaft of the transmission side or an output shaft of the differential gear side is inserted directly into an inner-race member of the constant-velocity joint along the axial direction, as discussed in Patent Document 1.

### REFERENCES ABOUT PRIOR ART

### Patent Documents

Patent Document 1: U.S. Pat. No. 7,677,981

### SUMMARY OF THE INVENTION

### Problems to be Solved by the Invention

The above-mentioned input/output shafts respectively have, however, different outer diameters or axial lengths or spline shapes according to differences of vehicle type, maker, etc.; in the conventional technique, it has therefore been necessary to independently produce adapter members agreeing with multiple variations of input/output shafts, which results in a complication of manufacturing operations and in a cost increase.

The present invention originates from the above-mentioned problems, to provide a propeller shaft adaptable to multiple variations of input/output shafts at low cost.

### Means for Solving the Problems

An invention as claimed in claim 1 is characterized by comprising:

a constant-velocity joint equipped with an outer-race member having in its axial direction one end side fixed to a hollow shaft body, an inner-race member disposed on an inner peripheral side of the outer-race member and having a female spline on its inner peripheral surface, and a rolling element located between the outer-race member and the inner-race member to connect these members with each other in a torque-transmittable manner; and

an adapter member having on its outer peripheral surface of its axial one end side a male spline to be engaged with the female spline of the inner-race member, while having on its inner peripheral surface of its axial other end side a female spline engageable with a male spline formed on an outer peripheral surface of a vehicle-side attaching shaft.

### Effects of the Invention

According to the invention as claimed in claim 1, by previously producing an adapter member the female spline of which agrees with the input/output shafts different therefrom in outer diameter or axial length or shape of the male spline due to differences of vehicle type, maker, etc. and by using the same, it becomes possible to attach the adapter member to a constant-velocity joint of an existing type. With this, a facilitation of the manufacturing operations and a cost reduction can be expected.

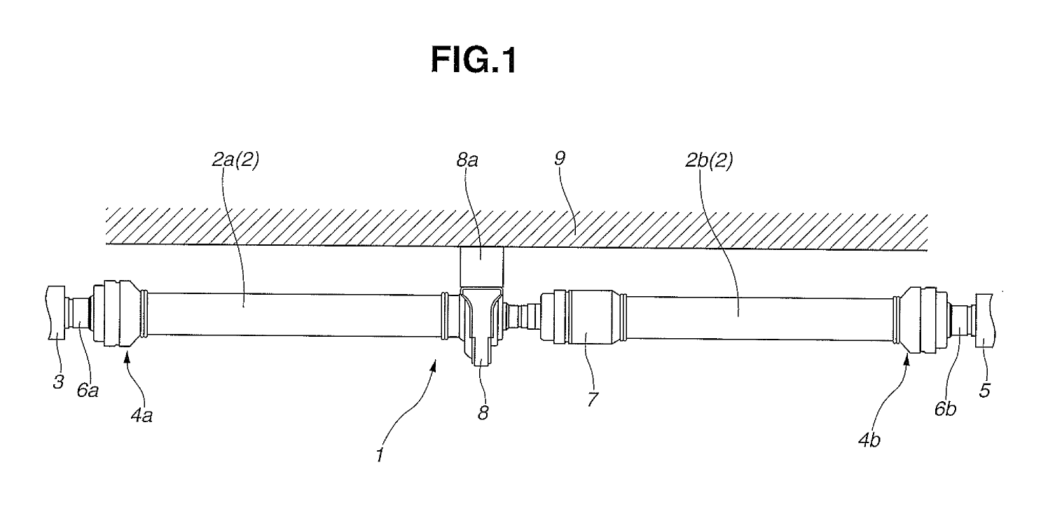

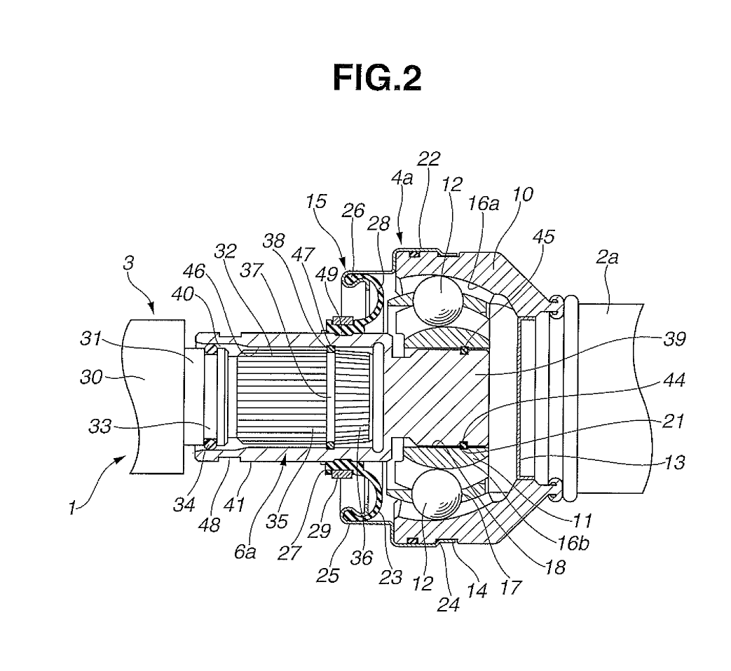

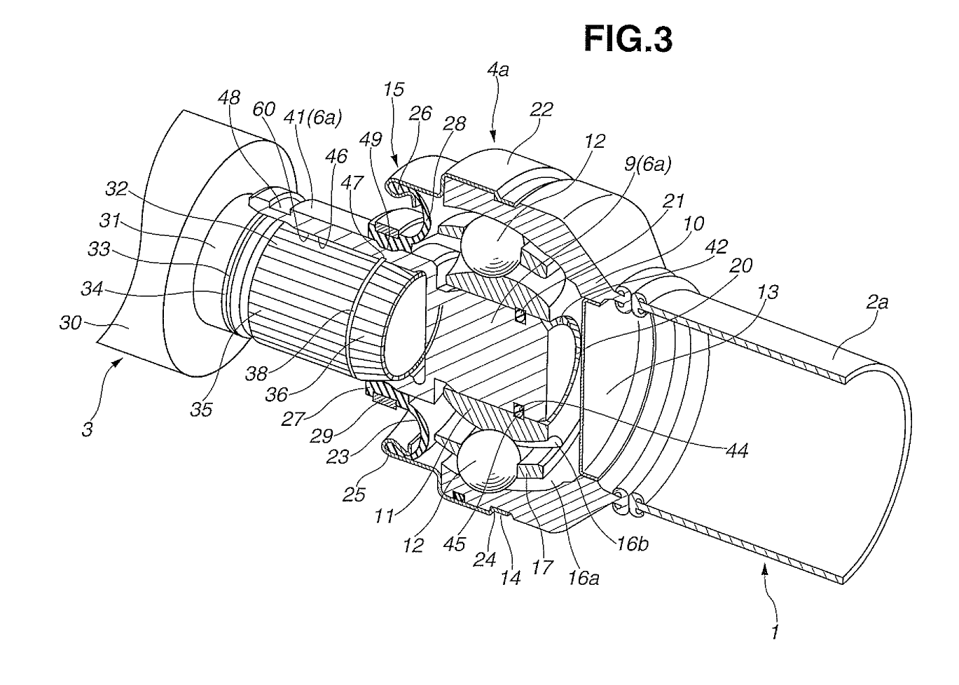

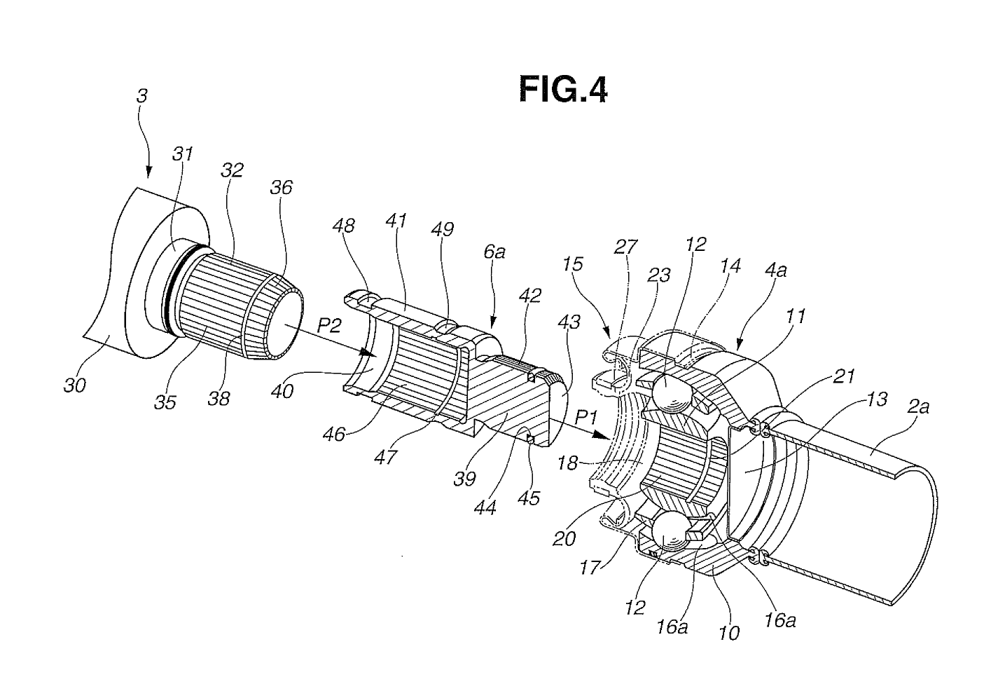

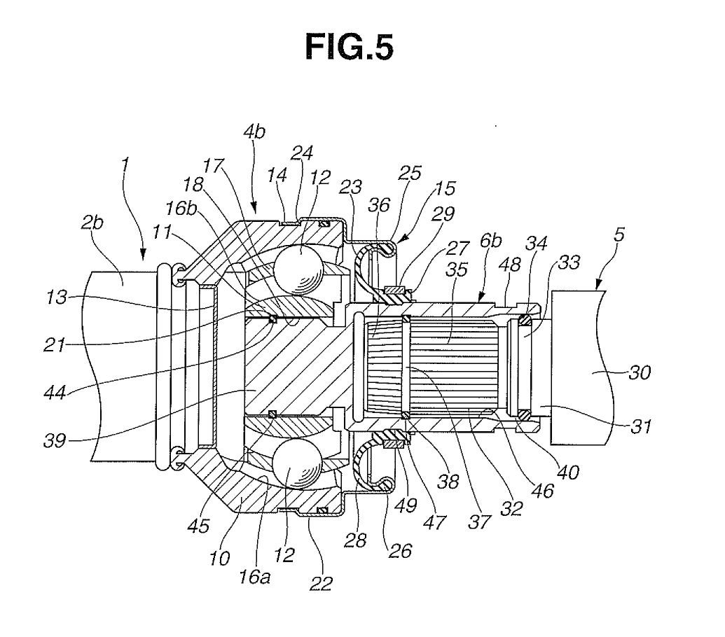

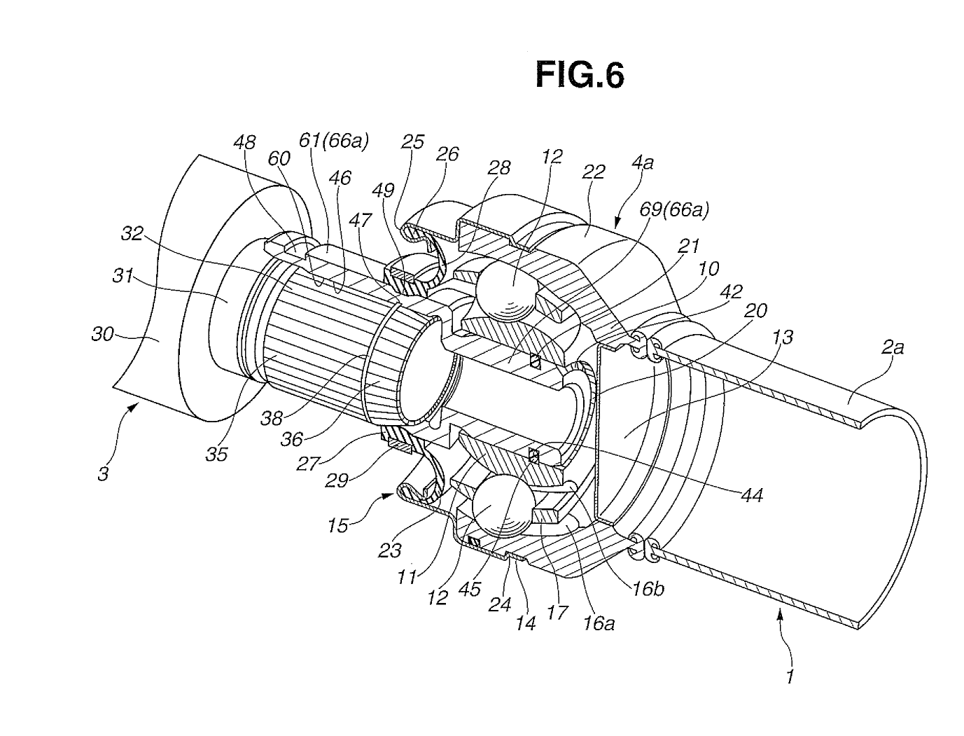

### BRIEF DESCRIPTION OF THE DRAWINGS

[FIG. 1] A schematic explanatory view of a first embodiment of a propeller shaft according to the present invention.

[FIG. 2] An enlarged sectional view of a first constant-velocity joint as shown in FIG. 1.

[FIG. 3] A perspective view of the first constant-velocity joint as shown in FIG. 2.

[FIG. 4] An exploded perspective view of the first constant-velocity joint as shown in FIG. 2.

[FIG. 5] An enlarged sectional perspective view of a second constant-velocity joint as shown in FIG. 1.

[FIG. 6] An enlarged sectional perspective view of a first constant-velocity joint of a second embodiment according to the present invention.

### MODE(S) FOR CARRYING OUT THE INVENTION

### First Embodiment

A propeller shaft 1, as shown in FIG. 1, is designed to connect a transmission not shown and disposed on the forward side of a vehicle (which side corresponds to the left side of FIG. 1) to a differential unit not shown and disposed on the rearward side of the vehicle, thereby transmitting a rotational force of the transmission to the differential unit.

The propeller shaft 1 is provided to include: a tube 2 serving as a hollow shaft body; a first constant-velocity joint 4a interposed between the tube 2 and an input shaft 3 serving as a vehicle-side attaching shaft on the transmission side; and a second constant-velocity joint 4b interposed between the tube 2 and an output shaft 5 serving as a vehicle-side attaching shaft on the differential gear side. Between the first constant-velocity joint 4a and the input shaft 3, a first adapter member 6a for connecting the first constant-velocity joint 4a and the input shaft 3 is interposed. Between the second constant-velocity joint 4b and the output shaft 5, a second adapter member 6b for connecting the second constant-velocity joint 4b and the output shaft 5 is interposed.

The tube 2 is a cylindrical shaft formed of an aluminum alloy, for example, and it is comprised of a front tube 2a on the side of the input shaft 3 and a rear tube 2b on the side of the output shaft 5. The front tube 2a and the rear tube 2b are connected with each other through a sliding-type constant-velocity joint 7. Incidentally, it is also possible to make the tube 2 from an iron-based material or CFRP. Additionally, the tube 2 is rotatably supported on the bottom surface of a vehicle floor 9 by a bearing bracket 8a having a center bearing 8 on the inner side.

The first constant-velocity joint 4a, as shown in FIGS. 2 to 4, is of the so-called stationary type and comprised of an outer-race member 10 having one end side fixed to the front tube 2a; an inner-race member 11 disposed on an inner peripheral side of the outer-race member 10 to receive a torque from the input shaft 3 through the first adapter member 6a; two or more balls as rolling elements rotatably provided between the outer-race member 10 and the inner-race member 11 to connect the members 10 and 11 with each other in a torque-transmittable manner; and a boot member 15 so mounted as to extend through the outer peripheral surface of the outer race member 10 and the outer peripheral surface of the first adapter member 6a and to hold grease inside the first constant-velocity joint 4a.

The outer-race member 10 is generally cylindrically formed from a metal material such as iron-based one and gradually decreased in diameter from an almost middle position in the axial direction toward the front tube 2a, and additionally connected at the top surface of this diameter-decreasing portion to the end surface of the front tube 2a by friction welding. Furthermore, the inner peripheral surface of the outer-race member 10 is approximately spherically defined. Into the inner peripheral surface of the outer-race member 10 and at an end section on the side of the front tube 2a, a disc-shaped sealing cap 13 is press-fitted. Moreover, the outer-race member 10 is formed with an annular mounting groove 14 on its outer peripheral surface and on the side of the input shaft 3

Incidentally, the outer-race member 10 is formed to have a plurality of ball grooves 16a in circumferentially equidistant locations on the inner peripheral surface, while the inner-race member 11 is formed to have a plurality of ball grooves 16b in circumferentially equidistant locations on the outer peripheral surface. Between the ball grooves 16a and ball grooves 1b, balls 12 are disposed through a cage 17 thereby allowing transmitting a torque from the inner-race member 11 to the outer-race member 10.

The inner-race member 11 is formed from a metal material such as iron-based one with a through hole 18 piercing in the internal axial direction. All over the inner peripheral surface defining the through hole 18 (i.e., the inner peripheral surface of the inner-race member 11), female splines 20 behaving as mounted sections in the inner-race member 11 are formed along the axial direction. The female splines 20 are to be engaged with male splines 42 behaving as mounting sections in the adapter member 6a. Furthermore, around a part that the female splines 20 have on the side of the front tube 2a, an annular holding groove 21 into which a circlip 45 of the adapter member 6a side is fitted is formed.

As shown in FIGS. 2 and 3, the boot member 15 is provided to include: a retainer 22 made of a metal plate; and a boot 23 made of, for example, a synthetic rubber material or a synthetic resin material.

The retainer 22 is formed into a cylinder having a stepwise shape as a whole, has a base portion 24 formed bent to have a crank-shaped cross section and fittingly fixed in the mounting groove 14 of the outer-race member 10, and additionally bent at a top end portion 25 to have a folded shape.

The boot 23 is annularly formed as a whole and generally shaped into a couched letter U in cross section. It is provided with an outer peripheral portion 26 having a tongue-like shape, an inner peripheral portion 27 having a generally rectangular cross section, and an arcuately projecting portion 28 connecting the outer peripheral portion 26 and the inner peripheral portion 27 with each other while projecting toward the balls 12. With this structure, it is possible to modify the shape of the boot 23 in the axial and radial directions.

The outer peripheral portion 26 is press-fittingly fixed inside the folded top end portion 25 of the retainer 22, while the inner peripheral portion 27 is fastened on the outer peripheral surface of the adapter member 6a by a boot band 29. Such a structure allows the boot member 15 to hold grease charged into the constant-velocity joint 4a in cooperation with the sealing cap 13.

The input shaft 3 is provided to have a stepwise-shape at its one end including: a larger diameter portion 30 attached to the transmission; a medium diameter portion 31 integrally connected to an end section of the larger diameter portion 30; and a smaller diameter portion 32 integrally connected to an end section of the medium diameter portion 31.

The medium diameter portion 31 is formed relatively short in length in the axial direction, and formed with a seal ring groove 33 on its outer peripheral surface and around an axially middle part. An annular seal ring 34 is provided to be tightly received in the seal ring groove 33.

The smaller diameter portion 32 is formed longer than the medium diameter portion 31 in the axial direction and formed having, all over its outer peripheral surface, axially-extending male splines 35 serving as mounting sections in the vehicle-side attaching shaft. Moreover, the smaller diameter portion 32 is provided to have an edge region 36 shaped getting thinner or tapered. The edge region 36 is formed with an annular clip groove 37 on the outer peripheral surface and on the side of a major region. An annular circlip 38 is tightly received in the clip groove 37, for preventing the input shaft 3 from disengaging from the adapter member 6a.

The first adapter member 6a is a single member formed of an iron-based material, for instance, and having the so-called stepwise cylindrical shape as a whole as shown in FIGS. 2 to 4. The first adapter member 6a is provided to comprise: a solid small-diameter shaft section 39 located on one end side in the axial direction and inserted into the through hole 18 of the inner-race member 11; and a large-diameter shaft section 41 having a hollow and cylindrical shape, located on the other end side in the axial direction, and formed with an insertion opening 40 in the internal axial direction into which the medium diameter portion 31 and the smaller diameter portion 32 of the input shaft 3 are inserted.

In the small-diameter shaft section 39, the male splines 42 serving as mounting sections engaged with the female splines 20 of the inner-race member 11 are formed all over the outer peripheral surface and in the axial direction by means of hobbing, for example. Furthermore, a tip section 43 is provided, on which side the small-diameter shaft section 39 is shaped getting thinner or tapered. The small-diameter shaft section 39 is formed with an annular clip groove 44 on the outer peripheral surface of the side of the tip region 43. A circlip 45 engaged in the holding groove 21 is fittingly fixed in the clip groove 44, thereby restraining the small-diameter shaft section 39 from disengaging from the through hole 18 of the inner-race member 11.

The large-diameter shaft section 41 is formed larger than the small-diameter shaft section 39 in both axial length and outer diameter, and formed to have, inside the insertion opening 40, a region corresponding to the smaller diameter portion 32 of the input shaft 3. On the input shaft 3 side of this region, female splines 46 to be engaged with the male splines 35 of the input shaft 3 are formed along the axial direction by means of broaching, for instance. Meanwhile, on the small-diameter shaft section 39 side of the region corresponding to the smaller diameter portion 32, there is formed an annular retaining groove 47 into which the circlip 38 is fittingly fixed.

Moreover, the large-diameter shaft section 41 further has an annular engaging groove 48 on the outer peripheral surface of a region toward the larger diameter portion 30. A tool for removing the input shaft 3 from the adapter member 6a is to be engaged with this engaging groove 48, though not illustrated.

Moreover, the large-diameter shaft section 41 further has an annular attaching groove 49 on the outer peripheral surface of a region toward the small-diameter shaft section 39. In the attaching groove 49, the above-mentioned inner peripheral portion 27 of the boot 23 is tightly received. The attaching groove 49 is defined to have a substantially trapezoidal cross section, the bottommost portion of which is offset in the axial direction by the bottommost portion of the retaining groove 47 also defined to have a substantially trapezoidal cross section. Thus the large-diameter shaft section 41 is prevented from increasing in thickness and ensured of strength. In order to further prevent the large-diameter shaft section 41 from increasing in thickness and to further ensure its strength, it is preferable that the attaching groove 49 as a whole is offset by the retaining groove 47 as a whole in the axial direction.

By the way, the first adapter member 6a is fixed integral with the first constant-velocity joint 4a in advance in a parts-assembling factory, for example, in such a manner that the small-diameter shaft section 39 is inserted into the through hole 18 of the inner-race member 11 in the axial direction as indicated in FIG. 4 by an arrow P1.

In this case, the first adapter member 6a comes to enter the through hole 18 such that the male splines 42 are guided on the female splines 20 of the inner-race member 11 side along the axial direction to be brought into engagement therewith, while being restrained from rotation. Then, the first adapter member 6a is elastically fittingly engaged with the holding groove 13 of the female splines 20 at the circlip 45 and therefore fixed while being subjected to a relative axial positioning with respect to the inner-race member 11. In other words, the holding groove 21 functions as a positioning section in the inner-race member 11 through the circlip 45, so that the operational efficiency in the parts-assembling factory is improved.

The first adapter member 6a having previously been fixed integral with the first constant-velocity joint 4a then receives the input shaft 3 in a vehicle-body-assembling factory, for example, such that the smaller diameter portion 32 of the input shaft 3 is inserted into the insertion opening 40 of the large-diameter shaft section 41 from the axial direction as indicated in FIG. 4 by an arrow P2. Thus the first constant-velocity joint 4a is connected to the input shaft 3 through the first adapter member 6a.

In this case, the input shaft 3 comes to enter the through hole 40 such that the male splines 35 are guided on the female splines 46 of the adapter member 6a side along the axial direction to be brought into engagement therewith, while being restrained from rotation. Then, the input shaft 3 is fittingly engaged with the retaining groove 47 of the female splines 46 at the circlip 38 in a manner elastically forced in a diameter-increasing direction, and therefore fixed while being subjected to a relative axial positioning with respect to the adapter member 6a. In other words, the retaining groove 47 functions as a positioning section in the adapter member 6a, so that the operational efficiency in the vehicle-body-assembling factory is improved.

According to the thus arranged embodiment, the first constant-velocity joint 4a is connected to the input shaft 3 through a separate part (i.e., the first adapter member 6a) as discussed above. With this arrangement, it is possible to adapt to cases of using an input shaft 3 different from existing ones in outer diameter or axial length or shape of the male splines 35 due to differences of vehicle type, maker, etc. without newly producing the first constant-velocity joint 4a itself composed of a plurality of members such as the outer-race member 10, the inner-race member 11 and the like, by previously producing an adapter member 6a the female splines 46 of which agree with the outer diameter or axial length or shape of the male splines 35. The same goes for the output shaft 5, the second constant-velocity joint 4b and the second adapter member 6b.

According to the present embodiment, the first and second adapter members 6a, 6b are able to be adapted to the input and output shafts 3, 5 differing in outer diameter etc., without newly producing the first and second constant-velocity joints 4a, 4b itself composed of a plurality of members as before. Since a facilitation of the manufacturing operations and a cost reduction can be expected, it is possible to adapt wide variations of input and output shafts 3, 5 at a low cost.

Moreover, the small-diameter shaft section 39 of the adapter member 6a is inserted into the through hole 18 of the inner-race member 11 to be fixed, so that the inner-race member 11 and the first constant-velocity joint 4a equipped with the inner-race member 11 are prevented from increasing in size.

Additionally, since the adapter member 6a is formed with the attaching groove 49 and the engaging groove 48 on its outer peripheral surface of the large-diameter shaft section 41, operations for providing both grooves may be achieved with ease.

In addition, the adapter member 6a is provided as a single member; therefore, as compared with conventional techniques where the adapter member is attached onto the outer peripheral surface of a sleeve of the inner-race member, the axial length of the large-diameter shaft section 41 (corresponding to the sleeve) can be modified with facility. With this, it is possible to enhance the attaching efficiency and the design flexibility of the boot member 15 to be attached onto the outer peripheral surface of the large-diameter shaft section 41.

Furthermore, the adapter member 6a is fixed integral with the inner-race member 11 of the first constant-velocity joint 4a in advance in a vehicle-parts-assembling factory and then attached to the input shaft 3 in a vehicle-body-assembling factory, for instance. Hence it is possible to improve the operational efficiency in the vehicle parts-assembling factory.

As shown in FIG. 5, the second constant-velocity joint 4b has the same structure as the first constant-velocity joint 4a has, in which an outer-race member 10 is fixed at its one end side a rear tube 2b while the output shaft 5 is inserted into an insertion opening 40 of the adapter member 6b.

### Second Embodiment

FIG. 6 illustrates a second embodiment of the present invention wherein the structure is changed only at a first adapter member 66a. Therefore, parts common to FIG. 3 are respectively given the same reference numerals and detailed descriptions thereof are omitted.

More specifically, in the second embodiment, the solid small-diameter shaft section 39 as shown in FIG. 3 is provided as a hollow cylindrical small-diameter shaft section 69 and therefore the first adapter member 66a has a hollow cylindrical shape as a whole.

According to the second embodiment, it is possible not only to obtain the same effects that the first embodiment provides as a matter of course, but also to reduce the first adapter member 66a in weight and material cost since the small-diameter shaft section 39 is also shaped into a hollow cylinder. Additionally, the first adapter member 66a takes on such a structure that a large-diameter shaft section 61 opens at both ends of an insertion opening 60, before being assembled; therefore the above-mentioned operation for forming the female splines 46 by means of broaching etc. becomes easier as compared with the first embodiment.

Hereinafter, inventions ascertainable from the above embodiments but not written in the claims will be discussed as follows.

### [Claim a]

A propeller shaft as claimed in claim 1, characterized in that the adapter member is attached to the vehicle-side attaching shaft in a state of being fixed integral with the inner-race member.

According to this invention, the operational efficiency in the vehicle-body-assembling factory etc. may be improved.

### Claim b

A propeller shaft as claimed in claim a, characterized in that the constant-velocity joint comprises a flexuous boot member holding grease therein, the flexuous boot member being mounted to extend through an outer peripheral surface of the outer-race member and an outer peripheral surface of the adapter member.

According to this invention, the adapter member is provided as a part separate from the constant-velocity joint thereby exhibiting good design flexibility. Therefore, it is possible to enhance the attaching efficiency and the design flexibility of the flexuous boot member.

### Claim c

A propeller shaft as claimed in claim 1, characterized in that the adapter member comprises a large-diameter shaft section and a small-diameter shaft section having an outer diameter smaller than that of the large-diameter shaft section, the male spline of the adapter member being formed on the outer peripheral surface of the small-diameter shaft section while the female spline of the adapter member is formed on the inner peripheral surface of the large-diameter shaft section.

According to this invention, the adapter member is provided with the male spline on the outer peripheral surface of the small-diameter shaft section, so that the inner-race member having on its inner peripheral surface the female spline engageable with the male spline is prevented from increasing in size.

### Claim d

A propeller shaft as claimed in claim 1, characterized in that the adapter member has a cylindrical shape the internal portion of which is hollowed to define the inner peripheral surface on which the female spline of the adapter member is formed.

According to this invention, it is possible to facilitate the formation of the female spline by means of broaching, for instance.

### Claim e

A propeller shaft as claimed in claim 1, characterized in that the female spline of the adapter member is formed with a positioning section for allowing a relative axial positioning between the vehicle-side attaching shaft and the adapter member at the time of insertion of the vehicle-side attaching shaft.

According to this invention, it is possible to facilitate the assembling operation.

### Claim f

A propeller shaft as claimed in claim e, characterized in that the adapter member is formed having, on an outer peripheral surface of a section provided with the female spline, an annular attaching groove to which a boot member for holding grease inside the constant-velocity joint is attached, wherein the attaching groove and a retaining groove serving as the positioning section are offset in the axial direction by each other.

According to this invention, it becomes possible to prevent the adapter member from increasing in thickness.

### Claim g

A propeller shaft as claimed in claim e, characterized in that the adapter member is formed having, on an outer peripheral surface of a section provided with the female spline:

an annular attaching groove to which a boot member for holding grease inside the constant-velocity joint is attached; and

an engaging groove with which a tool for removing the vehicle-side attaching shaft from the adapter member is to be engaged.

According to this invention, it is possible to form the both grooves with great efficiency.

### Claim h

A propeller shaft as claimed in claim 2, characterized in that the adapter member is attached to the vehicle-side attaching shaft in a state of being fixed integral with the inner-race member.

According to this invention, the operational efficiency in the vehicle-body-assembling factory etc. may be improved.

### Claim i

A propeller shaft as claimed in claim h, characterized in that the constant-velocity joint comprises a flexuous boot member holding grease therein, the flexuous boot member being mounted to extend through an outer peripheral surface of the outer-race member and an outer peripheral surface of the adapter member.

According to this invention, the adapter member is provided as a part separate from the constant-velocity joint thereby exhibiting good design flexibility. Therefore, it is possible to enhance the attaching efficiency and the design flexibility of the flexuous boot member.

### Claim j

A propeller shaft as claimed in claim i, characterized in that the axial other end side of the adapter member is formed with a cylindrical section the internal portion of which is hollowed,

wherein the cylindrical section is formed having, on its outer peripheral surface: an annular attaching groove to which the flexuous boot member is attached; and an engaging groove with which a tool for removing the vehicle-side attaching shaft from the adapter member is to be engaged.

According to this invention, it is possible to form the both grooves with great efficiency.

### Claim k

A propeller shaft as claimed in claim 2, characterized in that the mounted section of the adapter member is formed with a positioning section for allowing a relative axial positioning between the vehicle-side attaching shaft and the adapter member at the time of insertion of the vehicle-side attaching shaft.

According to this invention, it is possible to facilitate the assembling operation.

### Claim l

A propeller shaft as claimed in claim 2, characterized in that the adapter member comprises:

a large-diameter shaft section disposed on the axial one end side; and

a small-diameter shaft section disposed on the axial other end side and having an outer diameter smaller than that of the large-diameter shaft section,

wherein a male spline behaving as the mounting section in the adapter member is formed on an outer peripheral surface of the small-diameter shaft section, and a female spline behaving as the mounted section in the adapter member is formed on an inner peripheral surface of the large-diameter shaft section.

According to this invention, it is possible to prevent the inner-race member engageable with the mounting section of the adapter member is prevented from increasing in size.

### Claim m

A propeller shaft as claimed in claim 1, characterized in that the adapter member is substantially formed into a cylinder, and the female spline of the adapter member is formed on an inner peripheral surface of the cylinder.

According to this invention, it is possible to facilitate the formation of the female spline by means of broaching, for instance.

### Claim n

A propeller shaft as claimed in claim 1, characterized in that the female spline of the large-diameter shaft section of the adapter member is formed having an annular positioning groove for allowing a relative axial positioning between the vehicle-side attaching shaft and the adapter member at the time of insertion of the vehicle-side attaching shaft, and an outer peripheral surface of the large-diameter shaft section is formed with an annular attaching groove to which a boot member for holding grease inside the outer-race member is attached,

wherein the positioning groove and the attaching groove are offset in the axial direction by each other.

According to this invention, it becomes possible to prevent the large-diameter shaft section from increasing in thickness.

### EXPLANATION OF REFERENCE NUMERALS

1 Propeller shaft

2a Front tube (Hollow shaft body)

2b Rear tube (Hollow shaft body)

3 Input shaft (Vehicle-side attaching shaft)

4a First constant-velocity joint (Constant-velocity joint)

4b Second constant-velocity joint (Constant-velocity joint)

5 Output shaft (Vehicle-side attaching shaft)

6a First adapter member

6b Second adapter member

10 Outer-race member

11 Inner-race member

12 Ball (Rolling element)

20 Female spline (Mounted section in the inner-race member)

35 Male spline (Mounting section in the vehicle-side attaching shaft)

42 Male spline

46 Female spline

66a First adapter member

1. A propeller shaft comprising:
a constant-velocity joint equipped with an outer-race member having in its axial direction one end side fixed to a hollow shaft body, an inner-race member disposed on an inner peripheral side of the outer-race member and having a female spline on its inner peripheral surface, and a rolling element located between the outer-race member and the inner-race member to connect these members with each other in a torque-transmittable manner; and
an adapter member having on its outer peripheral surface of its axial one end side a male spline to be engaged with the female spline of the inner-race member, while having on its inner peripheral surface of its axial other end side a female spline engageable with a male spline formed on an outer peripheral surface of a vehicle-side attaching shaft.

2. A propeller shaft as claimed in claim 1, wherein the adapter member is attached to the vehicle-side attaching shaft in a state of being fixed integral with the inner-race member.

3. A propeller shaft as claimed in claim 2, wherein the constant-velocity joint comprises a flexuous boot member holding grease therein, the flexuous boot member being mounted to extend through an outer peripheral surface of the outer-race member and an outer peripheral surface of the adapter member.

4. A propeller shaft as claimed in claim 1, wherein the adapter member comprises a large-diameter shaft section and a small-diameter shaft section having an outer diameter smaller than that of the large-diameter shaft section, the male spline of the adapter member being formed on the outer peripheral surface of the small-diameter shaft section while the female spline of the adapter member is formed on the inner peripheral surface of the large-diameter shaft section.

5. A propeller shaft as claimed in claim 1, wherein the adapter member has a cylindrical shape the internal portion of which is hollowed to define the inner peripheral surface on which the female spline of the adapter member is formed.

6. A propeller shaft as claimed in claim 1, wherein the female spline of the adapter member is formed with a positioning section for allowing a relative axial positioning between the vehicle-side attaching shaft and the adapter member at the time of insertion of the vehicle-side attaching shaft.

7. A propeller shaft as claimed in claim 6, wherein the adapter member is formed having, on an outer peripheral surface of a section provided with the female spline, an annular attaching groove to which a boot member for holding grease inside the constant-velocity joint is attached, wherein the attaching groove and a retaining groove serving as the positioning section are offset in the axial direction by each other.

8. A propeller shaft as claimed in claim 1, wherein the adapter member is formed having, on an outer peripheral surface of a section provided with the female spline:
an annular attaching groove to which a boot member for holding grease inside the constant-velocity joint is attached; and
an engaging groove with which a tool for removing the vehicle-side attaching shaft from the adapter member is to be engaged.

9. A propeller shaft comprising:
a constant-velocity joint equipped with an outer-race member having in its axial direction one end side fixed to a hollow shaft body, an inner-race member disposed on an inner peripheral side of the outer-race member and having a mounted section therein, and a rolling element located between the outer-race member and the inner-race member to connect these members with each other in a torque-transmittable manner; and
an adapter member having on its axial one end side a mounting section to be engaged with the mounted section of the inner-race member, while having on its axial other end side a mounted section arranged to be engageable with a mounting section of a vehicle-side attaching shaft.

10. A propeller shaft as claimed in claim 9, wherein the adapter member is attached to the vehicle-side attaching shaft in a state of being fixed integral with the inner-race member.

11. A propeller shaft as claimed in claim 10, wherein the constant-velocity joint comprises a flexuous boot member holding grease therein, the flexuous boot member being mounted to extend through an outer peripheral surface of the outer-race member and an outer peripheral surface of the adapter member.

12. A propeller shaft as claimed in claim 11, wherein the axial other end side of the adapter member is formed with a cylindrical section the internal portion of which is hollowed,
wherein the cylindrical section is formed having, on its outer peripheral surface: an annular attaching groove to which the flexuous boot member is attached; and an engaging groove with which a tool for removing the vehicle-side attaching shaft from the adapter member is to be engaged.

13. A propeller shaft as claimed in claim 9, wherein the mounted section of the adapter member is formed with a positioning section for allowing a relative axial positioning between the vehicle-side attaching shaft and the adapter member at the time of insertion of the vehicle-side attaching shaft.

14. A propeller shaft as claimed in claim 9, wherein the adapter member comprises:
a large-diameter shaft section disposed on the axial other end side; and
a small-diameter shaft section disposed on the axial one end side and having an outer diameter smaller than that of the large-diameter shaft section,
wherein a male spline behaving as the mounting section in the adapter member is formed on an outer peripheral surface of the small-diameter shaft section, and a female spline behaving as the mounted section in the adapter member is formed on an inner peripheral surface of the large-diameter shaft section.

15. A propeller shaft as claimed in claim 14, wherein the adapter member is substantially formed into a cylinder, and the female spline of the adapter member is formed on an inner peripheral surface of the cylinder.

16. A propeller shaft as claimed in claim 14, wherein the female spline of the large-diameter shaft section of the adapter member is formed having an annular positioning groove for allowing a relative axial positioning between the vehicle-side attaching shaft and the adapter member at the time of insertion of the vehicle-side attaching shaft, and an outer peripheral surface of the large-diameter shaft section is formed with an annular attaching groove to which a boot member for holding grease inside the outer-race member is attached,
wherein the positioning groove and the attaching groove are offset in the axial direction by each other.

17. An adapter member for a propeller shaft, comprising:
an axial one end side having on its outer peripheral surface a male spline arranged to be engageable with a female spline of a constant-velocity joint, the female spline of the constant-velocity joint being formed on an inner peripheral surface of an inner-race member of the constant-velocity joint; and
an axial other end side having on its inner peripheral surface a female spline arranged to be engageable with a male spline of a vehicle-side attaching shaft, the male spline of the vehicle-side attaching shaft being formed on an outer peripheral surface of the vehicle-side attaching shaft.
